(19) United States
(12) Patent Application Publication
(10) Pub. No.: US 2023/0184986 A1
(43) Pub. Date: Jun. 15, 2023

(54) METHODS FOR DETERMINING DIAGENETIC PATTERNS IN CARBONATE ROCKS BY RESONANCE AND PHOTOELECTRIC FACTOR PROFILES

(71) Applicant: Petróleo Brasileiro S.A. - Petrobras, Rio de Janeiro (BR)

(72) Inventor: Marcelo Fagundes De Rezende, Rio de Janeiro (BR)

(21) Appl. No.: 18/078,623

(22) Filed: Dec. 9, 2022

(30) Foreign Application Priority Data
Dec. 10, 2021 (BR) 10 2021 025082 8

(51) Int. Cl. G01V 3/32; E21B 49/00

(52) U.S. Cl. CPC G01V 3/32; E21B 49/00

(57) ABSTRACT

The present invention proposes a method for determining diagenetic patterns in carbonate rocks by resonance and photoelectric factor profiles. It refers to an analytical method to individualize two distinct patterns of diagenetic evolution from statistical treatment, a normal evolution pattern with diagenesis acting on the porous system, and an inverse pattern with diagenesis acting on rock particles.

A method for determining diagenetic patterns in carbonate rocks by resonance and photoelectric factor profiles, characterized in that: a) selecting the electrical profiles measured in the well; b) assessing well intervals under the method application conditions; c) calculating the Pearson’s correlation coefficient between the two variables, photoelectric factor and effective porosity of nuclear magnetic resonance; d) choosing the thresholds for classifying the diagenetic patterns based on the r coefficient; e) applying the interval thickness filter to reduce to the sample scale of interest.

### CROSS-REFERENCE TO RELATED APPLICATION

This application claims priority to Brazilian Application No. 10 2021 025082 8, filed on Dec. 10, 2021, and entitled “METHODS FOR DETERMINING DIAGENETIC PATTERNS IN CARBONATE ROCKS BY RESONANCE AND PHOTOELECTRIC FACTOR PROFILES,” the disclosure of which is incorporated herein by reference in its entirety.

### FIELD OF THE INVENTION

The present invention can be applied to all fields that involve carbonate rocks as a target for hydrocarbon reservoirs, as long as nuclear magnetic resonance and photoelectric factor profiles thereof are available.

### DESCRIPTION OF THE STATE OF THE ART

In the oil and gas industry, identifying natural patterns formed by diagenetic processes in carbonate rocks from the evaluation of profiles is extremely important.

Effect of diagenesis in carbonate rocks is one of the most elusive issues in the petrophysical characterization of hydrocarbon reservoirs, although it is one of its main constraints. Methods that allow one to distinguish different patterns are of great importance in the process of characterizing and modeling reservoirs, as they allow a distinction to be made between reservoirs having different characteristics relative to the rock-pore system with different mineralogical and petrophysical properties.

Prior to the invention, determination of the non-pattern-oriented petrographic description was carried out and later there was a need for a rock-profile integration by experts in geology and petrophysics. The process of identifying diagenetic patterns in carbonate rocks was carried out, and still is in many cases, manually, through an interpretive process that us often non-numerical and difficult to reproduce.

Document CN107505663B discloses a method of constructing a classification board for carbonate reservoirs. It establishes a coordinate diagram in the shape of an equilateral triangle, where the bottom coordinate axis represents the amount of rock type change, the left coordinate axis represents the amount of sedimentary phase change, the right coordinate axis represents the amount of diagenetic type change, and the amount of rock type change is defined. The shale content decreases from left to right along the coordinate axis, and diagenesis of the water body energy variation and sedimentary face diagenetic type decreases from the top to the bottom along the coordinate axis.

Document CN104076038A discloses a method for representation and factor recognition of common carbonate rock diagenesis fabric features. The method makes it possible to identify the characterization and genesis of the diagenetic fabric (diagenetic environment) of carbonate rocks through microsampling of diagenetic structures in carbonate rocks and performing several geochemical analyses.

The cited prior arts do not disclose a differentiation of patterns along sections of carbonate rocks.

In view of the difficulties found in the cited state of the art, and for solutions to determine the diagenetic patterns in carbonate rocks by resonance and photoelectric factor profiles, there is a need to develop a technology capable of performing effectively and that is in accordance with the environmental and safety guidelines. The state of the art cited above does not provide the unique features that will be presented in detail below.

### OBJECT OF THE INVENTION

It is one object to expeditiously classify large sections of carbonate rocks and their reservoirs, allowing the early construction of geological reservoir models incorporating diagenetic aspects.

### BRIEF DESCRIPTION OF THE INVENTION

The present invention proposes a method for determining diagenetic patterns in carbonate rocks by resonance and photoelectric factor profiles.

It refers to an analytical method to individualize two distinct patterns of diagenetic evolution from statistical treatment, a normal evolution pattern with diagenesis acting on the porous system, and an inverse pattern with diagenesis acting on rock particles.

A method for determining diagenetic patterns in carbonate rocks by resonance and photoelectric factor profiles, characterized in that: a) selecting the electrical profiles measured in the well; b) assessing well intervals under the method application conditions; c) calculating the Pearson’s correlation coefficient between the two variables, photoelectric factor and effective porosity of nuclear magnetic resonance; d) choosing the thresholds for classifying the diagenetic patterns based on the r coefficient; e) applying the interval thickness filter to reduce to the sample scale of interest.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The present invention will be described in more detail below, with reference to the attached figures which, in a schematic and non-limiting manner of the scope of the invention, represent examples of embodiments. In the drawings:

FIG. 1 illustrates the placement of different diagenetic environments after sediment deposition and the porosity pattern formed in each one of them considering residence time and water percolation. Wherein: ZVS — Upper Vadose Zone; ZVI — Lower Vadose Zone; ZFS — Upper Phreatic Zone and ZFI— Lower Phreatic Zone.

FIG. 2 illustrates different diagenetic processes acting on a rock and their effects on the pore system and the final porosity of a rock. From the original porous system to those enlarged by diagenesis due to dissolution. Primary (a), reduced by diagenesis (b) and increased by diagenesis (c) .

FIG. 3 illustrates the response of different electrical profiles to diagenesis and different minerals of rock material. Specifically concerning the photoelectric factor, one of the curves used in this method shows variation in relation to porosity and fluids present in the pores.

FIG. 4 illustrates two competing diagenetic patterns calculated from mathematical derivation based on calcite and dolomite concentrations in a rock volume and its porosity, with effects on photoelectric factor values.

FIG. 5 illustrates the expected variations within each diagenetic pattern in terms of photoelectric factor and effective porosity, as well as the graphical representation of these patterns between profiles.

FIG. 6 illustrates the expected relationships between the diagenetic process acting on the porous system, its effect on porosity and the final diagenetic pattern per profile. Each pattern conditions a distinct permeability characteristic, with significant effects on reservoirs made of carbonate rocks. Primary (a) - primary porosity; reduced by digenesis (b) - positive (calcite cement, compaction, chemical clays, petrofacies with no primary porosity), negative (dolomite cement and silica); improved by diagenesis (c) - selective dissolution of scaffold grains, scaffold replacement.

FIG. 7 illustrates the equation for determining the Pearson correlation coefficient between two variables, in this case, photoelectric factor and effective porosity, indicating how each pattern is defined according to the relationships shown in FIG. 4. It also presents how to indicate zones of uncertainty, when the correlation between the two variables is very low. In FIG. 7 represented by any value between -0.25 and 0.25, values defined according to the sensitivity analysis.

FIG. 8 illustrates a generic application example of the method with the definition of various intervals classified within one or another diagenetic pattern in column pdr_Diag_1m. The values are compared with those classified manually (Pdr_Diag) and the classification similarity is noticed, even though the numerical method treats the values with a much greater variability. Similarity becomes more evident by applying an interval thickness filter to represent data in a similar sample window (Pdr_Diag_1m (S1m) as the manually classified data.

FIG. 9 illustrates the flowchart showing all the steps applied in this method to obtain diagenetic patterns by electrical profiles in carbonate rocks.

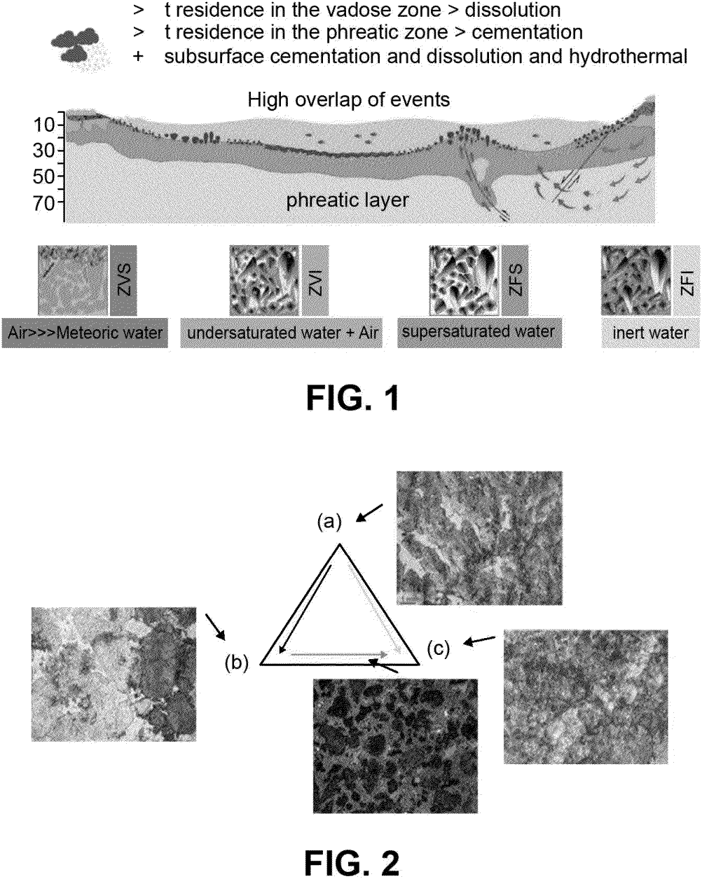

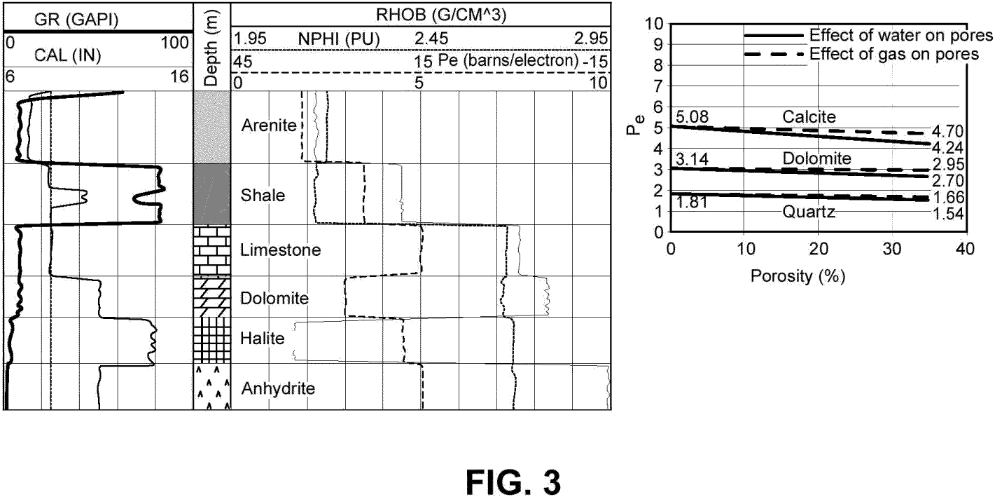

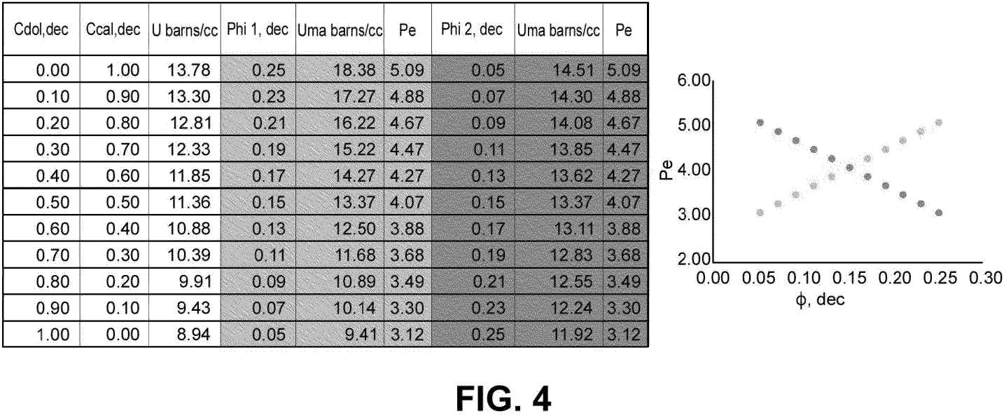

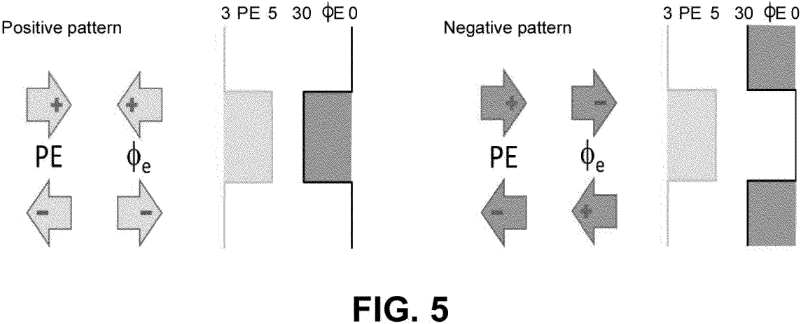

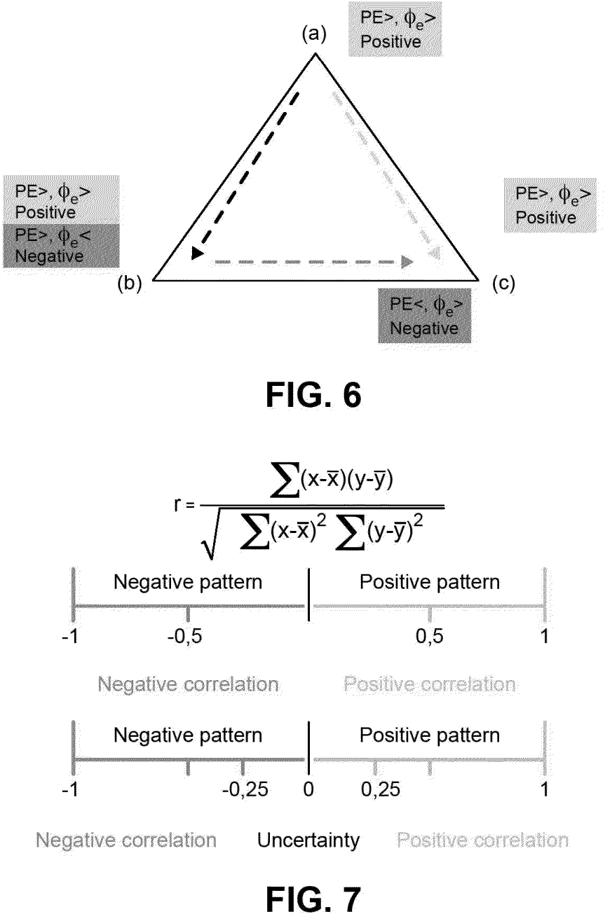

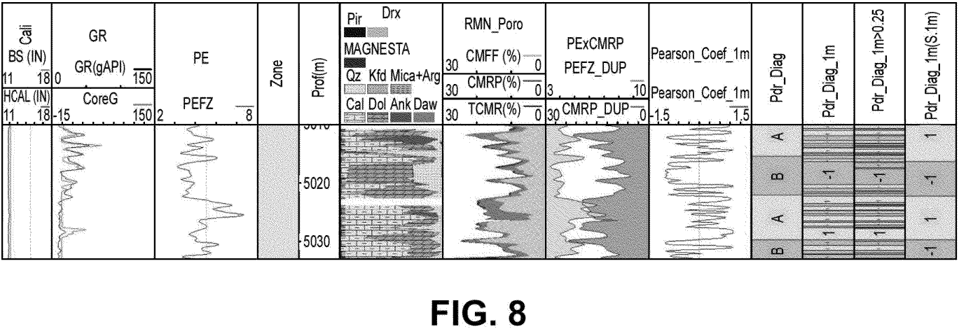

### DETAILED DESCRIPTION OF THE INVENTION

Below is a detailed description of a preferred embodiment of the present invention, which is given by way of example and is in no way limiting. Nevertheless, possible additional embodiments of the present invention still comprised by the essential and optional features below will be clear to a person skilled in the art from reading this description.

The invention solves the differentiation of patterns along sections of carbonate rocks by treating the relationships between electric porosity profiles by nuclear magnetic resonance and photoelectric factor. It can be adjusted according to users’ resolution needs to incorporate zones of uncertainty or undefined pattern. It uses the targeted application of Pearson’s correlation method in conjunction with the geological assessment of rocks, leading to the definition of an analytical process and computational solution capable of anticipating diagenetic patterns and consequently a better understanding of hydrocarbon reservoirs in carbonate rocks.

The invention provides productivity gains, as it enables one to expeditiously classify large sections of carbonate rocks and their reservoirs, allowing the early construction of geological reservoir models incorporating diagenetic aspects. It provides economic advantages as it increases the reliability of models and allows a better assessment of reserves and field production.

Method of calculation for pattern differentiation, controls for scale refinement, pattern classifier.

The calculation method for pattern differentiation is applied to profile data. The user adjusts the controls to refine the calculation scale. The measured depth intervals for each of the patterns or uncertainty zones are given.

The initial step involves selecting the electric profiles measured in the well from intervals of carbonate rocks and assessing their quality, both in relation to the environment of the well and in relation to the measurements obtained.

The next step involves the assessment of the well intervals under application conditions of the method. In summary, in well intervals with stable walls, with no indication of caliper breakout or zones with intense infiltration of drilling fluids, these intervals are mostly identifiable through the borehole profile and anomalies with very high values of porosity and photoelectric factor. These intervals are indicated as inappropriate for using the method as they affect the profile measurements.

Calculation of Pearson’s correlation coefficient between the two variables is performed, in this case, the photoelectric factor and effective porosity of nuclear magnetic resonance. Since the relationship is dimensionless, there is no difference in considering either one of the variables as a dependent. By convention, porosity was considered the independent variable and photoelectric factor the dependent variable.

The user chooses the limits for classifying the diagenetic patterns, based on established criteria for determining possible uncertainty zones.

An interval between two values is then classified with the user-defined pattern. In this case, values greater than 0 are classified in the positive correlation pattern and values lower than 0 are classified in the negative correlation pattern, which represent, respectively, a normal diagenetic pattern, with cementation or dissolution of the pore space and an inverse diagenetic pattern, with cementation of the pore space and selective dissolution of the scaffold grains.

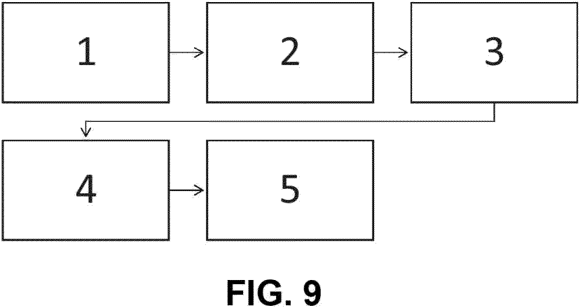

FIG. 9 illustrates the flowchart showing all the steps applied in this method to obtain diagenetic patterns by electrical profiles in carbonate:
1. Selection of photoelectric factor and porosity electric profiles;
2. Identification of zones with no collapse of the well wall for application of the method;
3. Calculation of Pearson’s correlation coefficient (r) in the chosen sampling window;
4. Classification of intervals in diagenetic patterns based on coefficient r;
5. Application of an interval thickness filter for reduction to the sample scale of interest.

If the user defines the existence of uncertainty zones, the intervals between these values are given as uncertainty rather than a diagenetic pattern.

The user then defines whether interval thickness filters are required for the intended work scale. If a thickness filter is not defined, then the result is the same as the previous step. If a thickness filter is defined, all layers of less than a given thickness are removed from the result of the previous step. This step is optional and allows one to evaluate the response of the method in different observation scales, while preserving data variability.

1. A method for determining diagenetic patterns in carbonate rocks by resonance and photoelectric factor profiles, characterized by:
a) selecting the electrical profiles measured in the well;
b) assessing the well intervals under the application conditions of the method;
c) calculating the Pearson’s correlation coefficient between the two variables, in this case, the photoelectric factor and effective porosity by nuclear magnetic resonance;
d) choosing the limits for classifying the diagenetic patterns based on coefficient r; and
e) applying the interval thickness filter for reduction to the sample scale of interest.

2. The method according to claim 1, characterized in that the intervals in step b) have stable walls, with no indication of caliper breakouts or areas with intense infiltration of drilling fluids.

3. The method according to claim 2, characterized in that the intervals are identifiable through the borehole profile and anomalies with very high values of porosity and photoelectric factor.

4. The method according to claim 1, characterized in that the interval between two values is classified with the pattern defined by the user.

5. The method according to claim 1, characterized in that the interval with values greater than zero are classified in the positive correlation pattern and with values lower than zero are classified in the negative correlation pattern; representing, respectively, a normal diagenetic pattern, with cementation or dissolution of the pore space and an inverse diagenetic pattern, with cementation of the pore space and selective dissolution of the scaffold grains.

6. The method according to claim 1, characterized in that, if the user defines the existence of uncertainty zones, the intervals between the values are given as uncertainty rather than a diagenetic pattern.

7. The method according to claim 2, characterized in that, if the user defines the existence of uncertainty zones, the intervals between the values are given as uncertainty rather than a diagenetic pattern.

8. The method according to claim 3, characterized in that, if the user defines the existence of uncertainty zones, the intervals between the values are given as uncertainty rather than a diagenetic pattern.

9. The method according to claim 4, characterized in that, if the user defines the existence of uncertainty zones, the intervals between the values are given as uncertainty rather than a diagenetic pattern.

10. The method according to claim 5, characterized in that, if the user defines the existence of uncertainty zones, the intervals between the values are given as uncertainty rather than a diagenetic pattern.

11. The method according to claim 2, characterized in that the interval between two values is classified with the pattern defined by the user.

12. The method according to claim 3, characterized in that the interval between two values is classified with the pattern defined by the user.

13. The method according to claim 2, characterized in that the interval with values greater than zero are classified in the positive correlation pattern and with values lower than zero are classified in the negative correlation pattern; representing, respectively, a normal diagenetic pattern, with cementation or dissolution of the pore space and an inverse diagenetic pattern, with cementation of the pore space and selective dissolution of the scaffold grains.

14. The method according to claim 3, characterized in that the interval with values greater than zero are classified in the positive correlation pattern and with values lower than zero are classified in the negative correlation pattern; representing, respectively, a normal diagenetic pattern, with cementation or dissolution of the pore space and an inverse diagenetic pattern, with cementation of the pore space and selective dissolution of the scaffold grains.

15. The method according to claim 4, characterized in that the interval with values greater than zero are classified in the positive correlation pattern and with values lower than zero are classified in the negative correlation pattern; representing, respectively, a normal diagenetic pattern, with cementation or dissolution of the pore space and an inverse diagenetic pattern, with cementation of the pore space and selective dissolution of the scaffold grains.
